(19) United States
(12) Patent Application Publication
(10) Pub. No.: US 2026/0171938 A1
(43) Pub. Date: Jun. 18, 2026

(54) CONTROL DEVICE FOR MOTOR, MOTOR, CONTROL DEVICE FOR POWER GENERATOR, POWER GENERATOR, AND WIND TURBINE

(71) Applicant: TDK CORPORATION, Tokyo (JP)

(72) Inventors: Tomokazu SHINJI, Tokyo (JP); Keiji TAKEDA, Tokyo (JP)

(73) Assignee: TDK CORPORATION, Tokyo (JP)

(21) Appl. No.: 19/115,829

(22) PCT Filed: Sep. 27, 2023
(86) PCT No.: PCT/JP2023/035167

§ 371 Date: Mar. 6, 2026

(30) Foreign Application Priority Data
Sep. 28, 2022 (JP) 2022-155178

(51) Int. Cl. H02P 9/00

(52) U.S. Cl. CPC H02P 9/00

(57) ABSTRACT

This control device for a motor, power generator or the like includes: current supply lines 42a, 42b, 42c which respectively supply currents of different phases to coils 32 (32a ) of the motor or power generator, which is provided with magnets; and a switching unit 44 which switches to a connected state or a disconnected state between the current supply lines.

### TECHNICAL FIELD

The present disclosure relates to a control device for motor, a motor, a control device for power generator, a power generator, and a wind turbine.

### BACKGROUND

As a technology relating to a motor and a control device controlling the motor, a technology of demagnetizing or magnetizing a magnet of the motor is proposed. For example, Patent Document 1 discloses that by demagnetizing or magnetizing the magnet of the motor, a speed torque property of the motor can be changed.

However, in order to demagnetize or magnetize the magnet of the motor, it is necessary to at least temporarily generate a strong magnetic force around the magnet. Thus, for example, it is necessary to generate a magnetic field to demagnetize or magnetize the magnet by flowing a larger current to the coil than that needed for rotating the motor.

Therefore, it is necessary to increase in size of an inverter for driving the motor; hence, ideas to downsize the inverter are demanded. Also, for example, there are demands to demagnetize or magnetize the magnet even for power generators such as a wind turbine, etc.

### PRIOR ART DOCUMENTS

### Patent Documents

[Patent Document 1] JP Patent Application Laid Open No. 2009-72046

### SUMMARY

Problems that the invention aims to solve

The object of the present disclosure is to provide a control device for motor, a motor, a control device for power generator, a power generator, and a wind turbine which can easily demagnetize or magnetize the magnet used for a motor or a power generator.

### Means for Solving the Object

In order to achieve the above-mentioned object, a control device for a motor according to one aspect of the present disclosure includes:
current supply lines respectively supplying currents having different phases to coils of the motor having a magnet, and
a switching unit switching a non-connected state and a connected state between the current supply lines.

When the current supply lines are maintained in a disconnected state by the switching unit, AC currents with different phases are supplied to the motor, and the motor rotates at a normal operation. In the case of demagnetizing or magnetizing the magnet provided to a rotor or a stator of the motor, the current supply lines are in the connected state due to the switching unit.

When the current supply lines having different phases are in the connected state, short circuit currents flow between the current supply lines, and due to this, current amplitudes become larger. Therefore, without changing output of an inverter and the like, a larger current than during the normal operation (for example, current larger by 2 times or more) can flow into coils of the motor. As a result, a magnetic field higher than (for example, higher by 1.8 times or more) a magnetic field applied during the normal operation is applied to the magnet of the motor; thus, the magnet can be easily demagnetized or magnetized.

Preferably, the switching unit includes a switching element switching the non-connected state and the connected state between the current supply lines. By arranging the switching element between the current supply lines, it is possible to switch the state of the current supply lines having different phases from the disconnected state to the connected state, or from the connected state to the disconnected state.

The control device may further include a capacitor (at least one) connected in series to the switching element. Note that, the capacitor connected in series to the switching element does not necessarily have to be arranged inside the switching unit; that is, it does not necessarily have to be arranged between the current supply lines. The capacitor may be arranged to the current supply lines, inside the motor, or inside the inverter. When the current supply lines are switched to the disconnected state using the switching element, from the point of stopping the capacitor function as well, the capacitor is preferably arranged between the current supply lines in series to the switching element.

Because of the capacitor connected in series to the switching element, a route which the short circuit current flows can be changed to either of a route which a capacitance impedance characteristic is dominating or a route which an induction impedance characteristic is dominating according to the frequencies of the currents.

Preferably, a part of or all of the magnet or magnets are variable magnetic flux magnets of low coercivities. For example, the variable flux magnet can be used for a variable magnetic force motor of automobiles, and by demagnetizing or magnetizing the magnet, the magnetic force of the magnet can be changed. Therefore, according to the operation state, a loss while the motor is driving can be reduced; hence a motor efficiency can be improved. Note that, “a variable magnetic flux magnet of low coercivity” refers to “the magnet having a lower coercivity than the magnetic field which can be applied using the coil of the motor and capable of changing the magnetic force by demagnetizing or magnetizing the magnet”.

Preferably, the control device further includes a control unit controlling a driving frequency of the motor and a movement of the switching unit. The control unit may control the driving frequency to a first predetermined frequency and may control the switching unit to bring the current supply lines to the connected state, and may demagnetize the magnet. Preferably, the first predetermined frequency is substantially the same as or greater than a resonant frequency of a circuit capable of resonating which is configured of a circuit including the coil of the motor and a circuit of the switching unit.

Also, the control unit may control the driving frequency to a second predetermined frequency and may control the switching unit to bring the current supply lines to the connected state for magnetizing the magnet. Preferably, the second predetermined frequency is lower than the first predetermined frequency. Preferably, the second predetermined frequency is substantially the same as or lower than the resonant frequency.

By having the capacitor connected to the switching element in series, a route of DC circuit will have a resonance point, and the route becomes a route which is dominated by a capacitance impedance characteristic at the second predetermined frequency which is lower than the resonance point. The route becomes a route which is dominated by an induction impedance characteristic at the first frequency which is higher than the resonance point. Therefore, at the first predetermined frequency, the magnetic field suited for demagnetization of the magnet is formed by the coil, and at the second predetermined frequency, the magnetic field suited for magnetization of the magnet is made by the coil. Note that, a frequency corresponds to a driving speed of the motor (for example, a rotational speed).

The control device may further include an inverter supplying the motor with the currents having different phases. By using the inverter, the currents of the predetermined frequencies with different phases can be supplied to the motor; thus, the motor can be operated at a predetermined driving speed (for example, a rotational speed).

The motor of the present disclosure is a motor including any one of the above-mentioned control device. Preferably, the motor of the present disclosure includes a rotor and a stator, and other motors such as a linear motor can be included as well. The magnet is preferably provided to the rotor, and the magnet may be provided to the stator.

A control device for a power generator of the present disclosure includes:
current supply lines respectively supplying currents having different phases to coils of the power generator having a magnet, and
a switching unit switching a non-connected state and a connected state between the current supply lines.

In a power generator, for example, by driving a moving body such as a rotor using forces such as hydropower, wind power, geothermal steam, wave power, induced electromotive force can be generated to the coil facing the magnet, and thereby enables to output electric power. However, the magnet for the power generator such as a wind turbine, for example, there may be cases that the magnet is demagnetized or degaussed due to lightning strike or so. In such case, conventionally, an extensive work will be needed to collect, transport, and dissemble to exchange the power generator; hence, this will cause extremely high cost particularly in the case of an offshore wind turbine.

In the control device for power generator of the present disclosure, by using the same device as the above-mentioned control device for motor, the magnet can be easily re-magnetized without exchanging the magnet of the power generator. Also, by using the same device as the above-mentioned control device for motor, the efficiency of the power generator can be improved by freely demagnetizing and magnetizing the magnet of the power generator.

As similar to the control device for motor, in the control device for power generator, the switching unit includes a switching element switching the non-connected state and the connected state between the current supply lines.

Also, as similar to the control device for motor, the control device for power generator may further include a capacitor (at least one) connected in series to the switching element.

Preferably, the control device for power generator includes a control unit controlling a detection unit detecting a driven unit frequency of a driven unit of the power generator, and controlling a movement of the switching unit. Preferably, the control unit magnetizes the magnet by bringing the current supply lines to the connected state by controlling the switching unit upon detecting that the driven unit frequency detected by the detection unit is substantially the same as or lower than a resonant frequency of a circuit capable of resonating by being configured of a circuit including the coils of the power generator and a circuit of the switching unit.

In the case that the driven frequency detected by the detection unit is smaller than the resonant frequency of the circuit capable of resonating, when the current supply lines are in the connected state by controlling the switching unit, there may be cases that the increase of the current amplitude provided by the inverter is not sufficient enough, and it may be difficult to magnetize the magnet. In contrast, in the case that the driven frequency detected by the detection unit is larger than the resonant frequency of the circuit capable of resonating, when the current supply lines are in a connected state by controlling the switching unit, the current amplitude supplied from the inverter is increased, for example, to 3 times or greater. As a result, the magnetic field applied to the magnet becomes larger; hence, the magnet can be magnetized efficiently.

### BRIEF DESCRIPTION OF DRAWINGS

FIG. 1A is a conceptual diagram of a control device for motor according to an embodiment of the present disclosure.

FIG. 1B is a conceptual diagram of a control device for power generator according to another embodiment of the present disclosure.

FIG. 2A is a cross-sectional view showing an example of a motor.

FIG. 2B is a cross-sectional view showing an example of a power generator.

FIG. 3 is a diagram of a graph of a B-H line of a magnet used for the motor, and it shows a concept of demagnetization and magnetization.

FIG. 4A is a graph of a phase current showing an example of a movement of a switching element shown in FIG. 1A.

FIG. 4B is a graph of a phase current showing another example of a movement of a switching element shown in FIG. 1A.

FIG. 4C is a graph of a phase current showing an example of a movement of a switching element shown in FIG. 1B.

FIG. 5A is a graph showing a change in a magnetic field applied to the magnet corresponding to FIG. 4A.

FIG. 5B is a graph showing a change in a magnetic field applied to the magnet corresponding to FIG. 4B.

FIG. 5C is a graph showing a change in a magnetic field applied to the magnet corresponding to FIG. 4C.

### DETAILED DESCRIPTION

In below, embodiments shown in the figures are described.

### First Embodiment

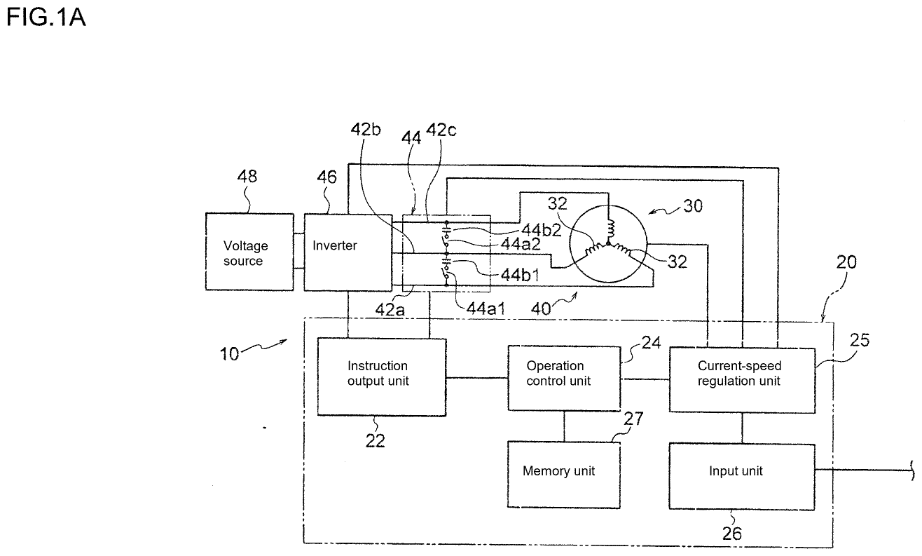

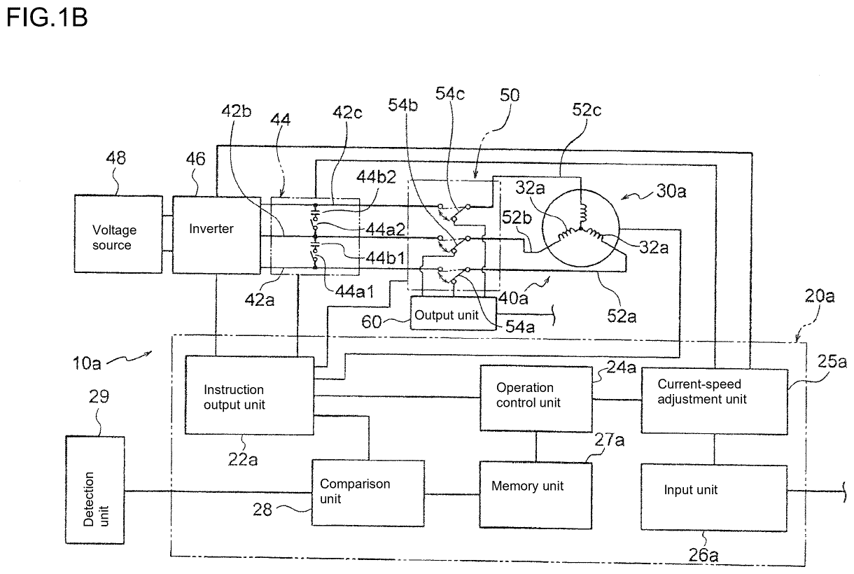

As shown in FIG. 1A, a control device 10 for motor of the present embodiment is a device controlling a movement of a motor 30, and includes a main control unit 20, a circuit 40 supplying current to the motor 30, a voltage source 48, an inverter 46, and a switching unit 44, and the like.

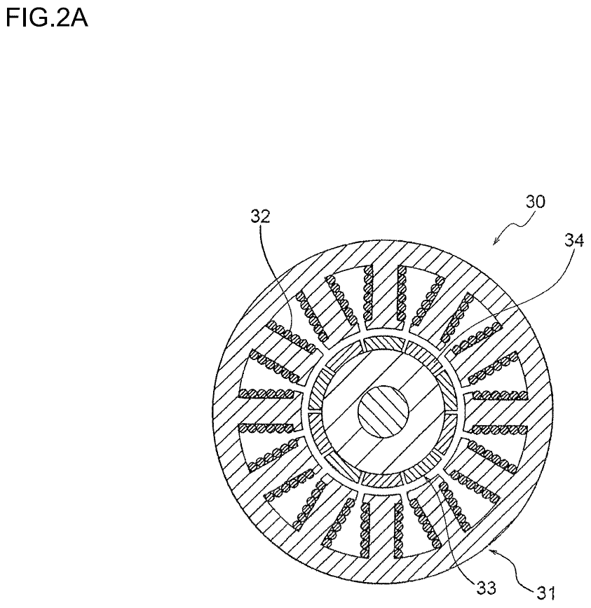

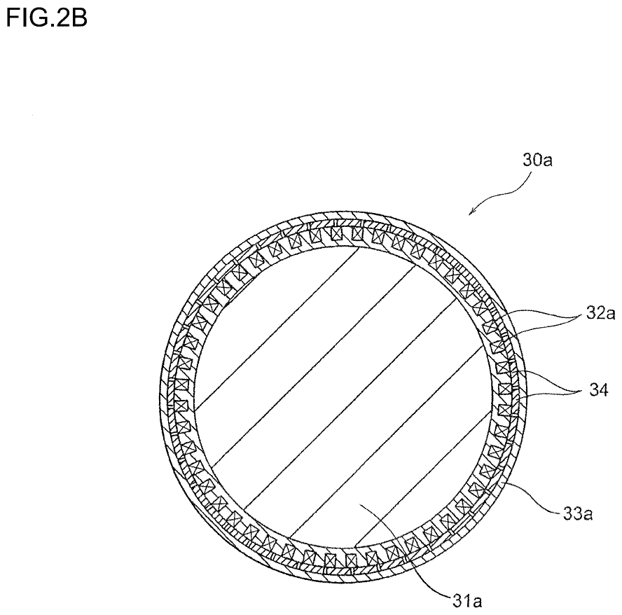

In the present embodiment, as the motor 30 controlled by the control device 10 for motor, the motor configured as shown in FIG. 2A is used as an example for explanation. However, a motor of other configurations, such as an interior permanent magnet synchronous motor (IPMSM), other permanent magnet (PM) motors may be used. Alternatively, the motor 30 may be a linear motor.

As shown in FIG. 1A, the main control unit 20 of the control device 10 for motor outputs instructions for controlling the motor 30 to the inverter 46 and the switching unit 44. For example, the main control unit 20 may output a control signal to the inverter 46 and the switching unit 44, or it may output an instruction data including data used to control the motor 30.

Also, the main control unit 20 acquires information such as a rotational speed of the motor 30. For example, the main control unit 20 may acquire information such as the rotational speed of the motor 30 via a resolver or a converter. Note that, a method for acquiring the rotational speed of the motor, a position of a rotor, and the like is not particularly limited; and an appropriate method may be selected according to a type of the motor, a controlling method, and the like.

The main control unit 20 includes an instruction output unit 22, an operation control unit 24, a current-speed regulation unit 25, an input unit 26, a memory unit 27, and the like. Note that, each of the operation control unit 24, the current-speed regulation unit 25, the input unit 26, the memory unit 27, and the like are a block representing a function which controls the motor 30. For example, these may be realized as independent devices or processing units, or two or more of these may be merged, or one part may be further divided. These may be configured using microprocessors, memories, and so on; and in such case, the function of the control device 10 for motor may be realized by executing appropriate software programs. For example, the main control unit 20 may be configured using one or more of specific hardware devices (such as integrated circuits).

The instruction output unit 22 shown in FIG. 1A instructs the circuit 40 including coils 32 in the motor 30 to output current which is supplied to the coils 32. For example, the instruction output unit 22 controls the inverter 46 and the switching unit 44 to regulate the current output, thereby controls the rotation of a rotor 33 of the motor 30 (see FIG. 2A), or controls magnetization or demagnetization of magnets 34 included in the motor 30 (see FIG. 2A).

The instruction output unit 22 is controlled by the operation control unit 24, the current-speed regulation unit 25, the memory unit 27, and the like. Note that, in FIG. 1A, the instruction output unit 22 is configured as a part of the main control unit 20; however, it may be configured as a separate part from the main control unit 20. The instruction of current output by the instruction output unit 22 is later described in details.

The main control unit 20 controls the instruction control unit 22 based on information such as a current value of the circuit 40, the rotational speed of the motor 30, external input information which is input via the input unit 26. The instruction control unit 22 controlled by the main control unit 20 outputs the instruction regarding the current supplied to the motor 30 to the inverter 46 and the switching unit 44.

The current-speed regulation unit 25 calculates a regulation value of the current output supplied to the circuit 40 based on information such as the speed (rotational speed) of the motor 30 and the external input information which is input via the input unit 26. The current-speed regulation unit 25 may, for example, carry out dq conversion of AC signal or calculate a gain of d-axis current and q-axis current based on UVW three-phase current from the circuit 40, information of the rotational speed of the motor 30, and the external input information.

The operation control unit 24 performs operation regulation of the motor 30 such as decoupling control. The operation control unit 24, for example, carries out signal processing to calculate voltage of each axis so that influence of the q-axis current on the d-axis voltage and influence of the d-axis current and magnetic flux on the q-axis voltage are canceled. Due to such decoupling control by the operation control unit 24, interference between the d-axis and the q-axis are decreased or resolved, and the control device 10 for motor can independently control the d-axis and the q-axis.

The memory unit 27 shown in FIG. 1A memorizes information used for the calculation by the operation control unit 24. The operation control unit 24 retrieves information from the memory unit 27 depending on needs, and the information can be used for calculation concerning the control of the motor 30.

The speed (rotational speed) instruction of the motor 30, the external input information such as current instruction are input into the input unit 26 of the control device 10 for motor shown in FIG. 1A. The external input information input into the input unit 26 is sent to the main control unit 20, and used for controlling the motor 30.

FIG. 2A is a cross-sectional view schematically showing the internal structure of the motor 30 shown in FIG. 1A. The motor 30 includes a rotor 33 configured of a plurality of magnets 34, and a stator 31 configured of a plurality of coils 32. In the specific example shown in FIG. 2A, the motor 30 includes twelve coils 32. The twelve coils 32 are arranged along a circumference direction with roughly an equal space in between. The rotor 33 is configured of ten magnets 34 which are arranged along the circumference direction with roughly an equal space in between, and the rotor can rotate around the approximate center position of the rotor 33 which is a rotational center.

As shown in FIG. 2A, the coils 32 are arranged so as to surround the rotor 33 configured of the magnets 34. The magnets 34 which are permanent magnets are installed on the surface of the rotor 33; however, the magnets 34 may be embedded inside.

Electromagnetic force which is generated by the magnetic field formed by the coils 32 acts on the magnets 34, and rotates the rotor 33 of the motor 30. Also, when a relatively strong magnetic field is formed around the magnets 34 by the coils 32, the magnets 34 are magnetized or demagnetized by the formed magnetic field. The motor 30 shown in FIG. 1A and FIG. 2A are the same in terms of including the coils 32 which rotates the motor 30 and the coils 32 to magnetize or demagnetize the magnets 34; however, a motor which is controlled by the control device 10 for motor shown in FIG. 1A is not limited to this.

For example, the motor which is controlled by the control device 10 for motor may be configured to magnetize or demagnetize the magnets 34 using coils 32 different from the coils 32 which are for rotating the motor; and it may be configured so as to magnetize or demagnetize the magnets 34 using a part of the coils 32 for rotating the motor 30.

The magnet 34 of the present embodiment is not particularly limited, and it may be a sintered magnet or a bond magnet. A material of the magnet is not particularly limited, and examples of the material of the magnet include an R-T-B-based permanent magnet, a Sm—Co-based permanent magnet, a ferrite-based permanent magnet, and an Alnico-based magnet. Also, as the magnet, preferably a variable magnetic flux magnet of low coercivity may be used.

A variable magnetic flux magnet is a magnet capable of switching the magnetized state depending on the magnetic field from the outside, and it can achieve a high magnetized sate and a low magnetized state in a reversible manner. A variable magnetic force motor installed with such variable magnetic flux magnet can control the magnetic field according to a rotational speed and a load state. For example, in the case that a high torque is required (during a low rotational speed or a high load), the magnetized state of the variable magnetic flux magnet is controlled to exhibit a large magnetic flux; and in the case that a high torque is not required, then the variable magnetic flux magnet is controlled to exhibit a small magnetic flux. Due to such variable magnetic flux magnet, efficiency of the variable magnetic force motor can be enhanced regardless of a torque value.

As shown in FIG. 1A, electric power is supplied to the coils 32 of the motor 30 via the current supply lines 42a, 42b, and 42c of the circuit 40. The coils 32 of the motor 30, the switching unit 44, and the inverter 46, and the like are connected to the current supply lines 42a, 42b, and 42c of the circuit 40.

Based on the instruction from the instruction output unit 22, the inverter 46 generates predetermined current and voltage in the circuit 40 using DC voltage from the voltage source 48. Specifically, the inverter 46 supplies different UVW three-phase currents (currents of predetermined frequencies) to each of the current supply lines 42a, 42b, and 42c. Note that, in the system shown in FIG. 1A, DC voltage from a battery as the voltage source 48 is used; however, the voltage source 48 for driving the motor 30 is not particularly limited to this, and the voltage source may be AC voltage.

The switching unit 44 shown in FIG. 1A includes a switching element 44a1 which switches the disconnected state and the connected (short circuit) state between the current supply lines 42a and 42b supplying currents having different phases to the coils 32. Also, the switching unit 44 includes a switching element 44a2 which switches the disconnected state and the connected state between the current supply lines 42b and 42c supplying currents having different phases to the coils 32.

Also, in the present embodiment, the switching unit 44 includes capacitors 44b1 and 44b2. The switching element 44a1 and the capacitor 44b1 are connected in series and the switching element 44a2 and the capacitor 44b2 are connected in series.

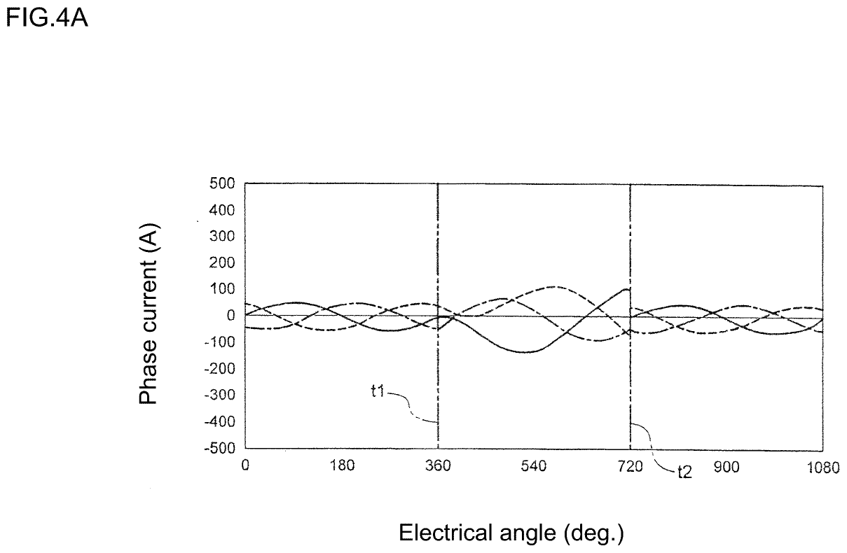

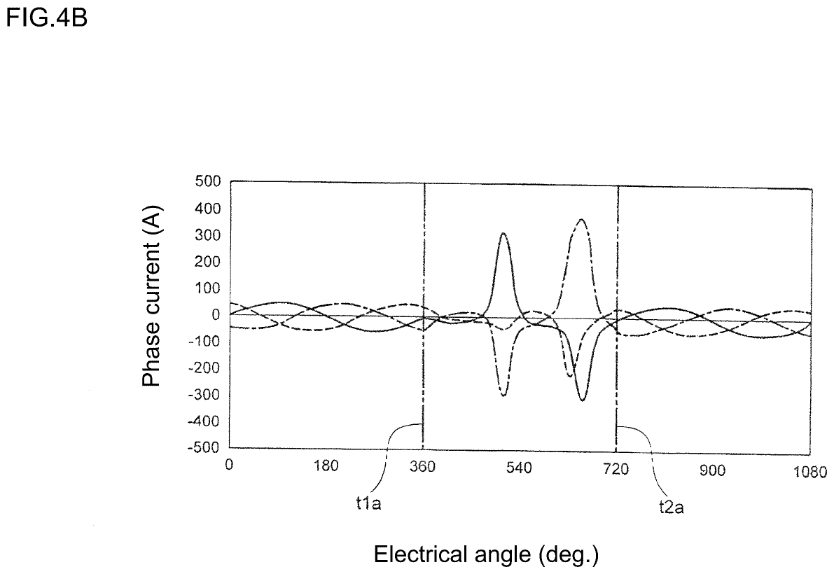

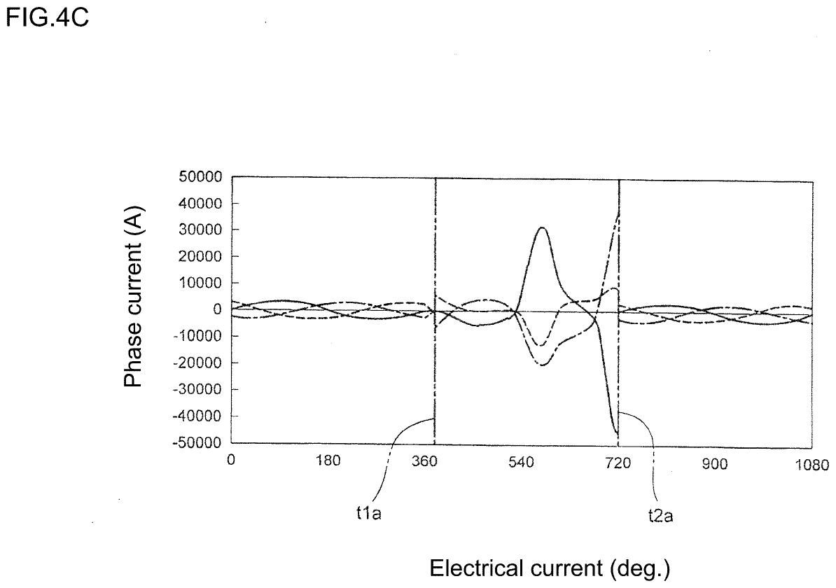

By sending or not sending a control signal to the switching unit 44 from the instruction output unit 22 of the main control unit 20, the switching elements 44a1 and 44a2 of the switching unit 44 are set to OFF state. When the switching elements 44a1 and 44a2 are in OFF state, the current supply lines 42a, 42b, and 42c are kept disconnected from each other. In such case, the three-phase currents flowing towards the coils 32 from the inverter 46 are maintained at the state which is before a timing t1 shown in FIG. 4A (that is, the left side from the t1 of FIG. 4A).

Under such state, AC currents of three phases having different phases are supplied to the coils 32 of the motor 30 shown in FIG. 1A, and the rotor 33 of the motor 30 (see FIG. 2A) is usually rotated at a first rotational speed corresponding to the first predetermined frequency. For example, at the timing t1 shown in FIG. 4A, in order to demagnetize the magnets 34 provided to the rotor 33 of the motor 30 shown in FIG. 2A, a control signal is sent to the switching unit 44 from the main control unit 20 shown in FIG. 1A, and the switching elements 44a1 and 44a2 are switched to ON. As a result, the current supply lines 42a, 42b, and 42c are in a connected state via the capacitors 44b1 and 44b2.

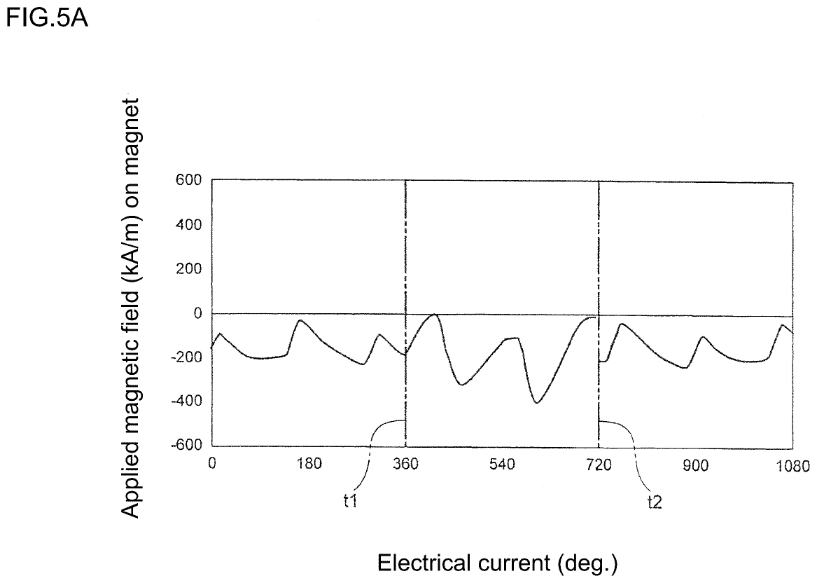

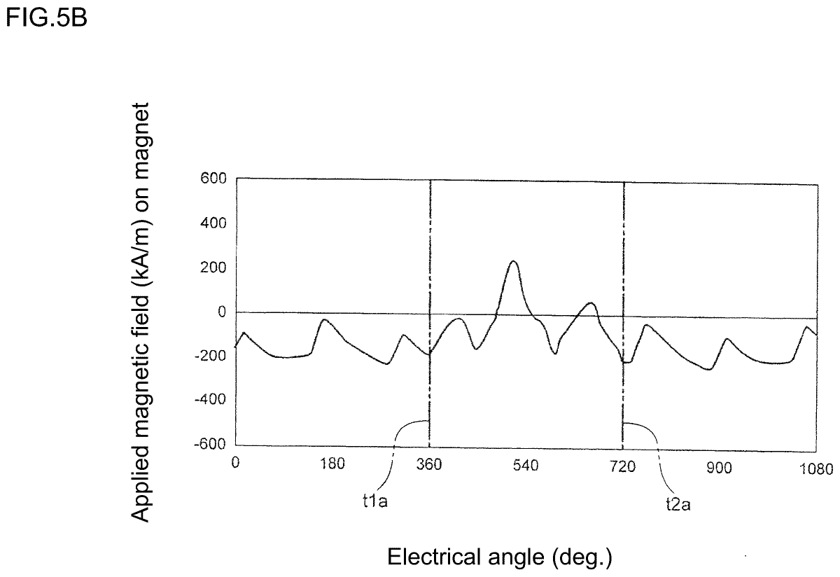

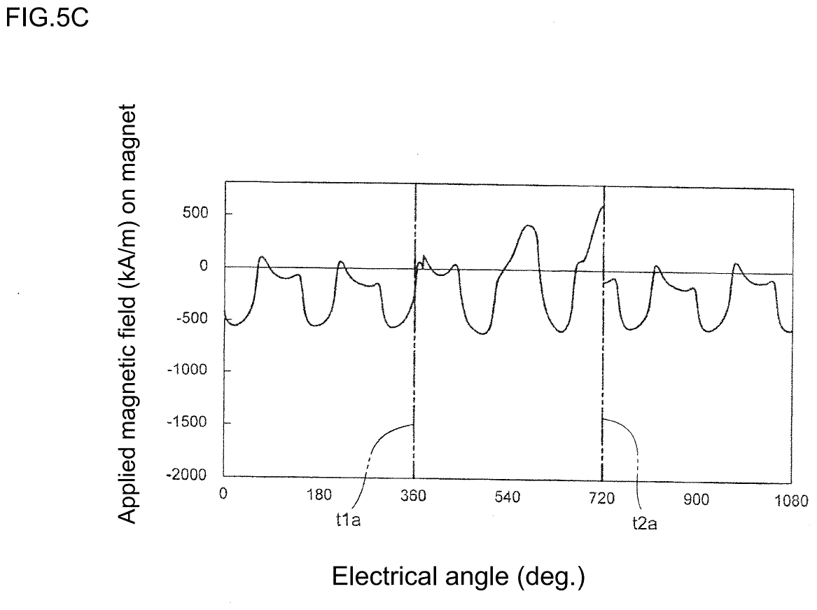

When the current supply lines 42a, 42b, and 42c, where currents having different phases are flowing, are in a connected state, a short circuit current runs between each of a pair of lines via the capacitors. Due to this, amplitudes of the currents increase as shown in after the timing t1 of FIG. 4A (that is, the right side of t1 of FIG. 4A). Therefore, a larger current (for example, twice or larger) than during usual operation can flow into the coils 32 of the motor 30 without changing the output of the inverter 40 and the like. As a result, as shown in after the timing t1 of FIG. 5A, a magnetic field higher in minus side (for example, 1.8 times or larger) than a magnetic field during the normal operation is applied on the magnets 34 of the motor 30 shown in FIG. 2A, hence the magnets 34 can be demagnetized.

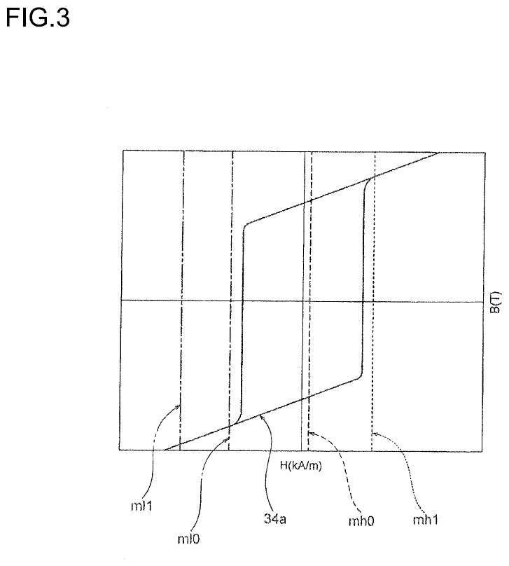

In the present embodiment, regarding a hysteresis curve 34a of a B-H curve of the magnets 34 shown in FIG. 3, for example, demagnetization can be carried out at a sufficiently large magnetic field ml1 (in a negative side). In regards with a conventional control device which does not have the switching unit 44 shown in FIG. 1A, when demagnetization is carried out, it is carried out at a magnetic field of ml0. That is, in the present embodiment, even when the output of the inverter 46 shown in FIG. 1A is further reduced, it is possible to demagnetize.

Also, at a timing t2 when demagnetization of the magnets 34 is completed (see FIG. 4A), a control signal is sent to the switching unit 44 from the main control unit 20 shown in FIG. 1A to switch OFF the switching elements 44a1 and 44a2. As a result, the connections between the current supply lines 42a, 42b, and 42c are disconnected from each other, hence short circuit currents do not flow. Note that, in the present embodiment, a short circuit currents refer to currents which flow between the current supply lines 42a, 42b, and 42c through or without going through the capacitors 44b1 and 44b2 at a stage before the current is supplied to the motor 30.

When the connection between the current supply lines 42a, 42b, and 42c are disconnected, the current flowing in each of the current supply lines 42a, 42b, and 42c returns to the state before the timing t1 as shown in after the timing t2 of FIG. 4A (the right side of FIG. 4A). Similarly, when the connection between the current supply lines 42a, 42b, and 42c are disconnected, the applied magnetic field supplied to each of the magnets 34 of the motor 30 returns to the state before the timing t1 as shown in after the timing t2 of FIG. 5A (the right side of FIG. 5A). As a result, the motor 30 returns back to the normal operation.

Note that, in FIG. 4A and FIG. 5A, an electrical angle shown in a horizontal axis corresponds to a time span, and the time span from the timing t1 to the timing t2 is, for example, several milli seconds to several seconds. During this time span, all of the magnets 34 of the motor 30 are demagnetized. After the magnets 34 are demagnetized, the motor 30 during the normal operation is controlled by the main control unit 20 shown in FIG. 1A.

Next, in the case of magnetizing the magnet of the motor 30, first, the motor 30 is controlled by the main control unit 20 shown in FIG. 1A to rotate the rotor 33 (see FIG. 2A) at a second rotational speed which corresponds to the second predetermined frequency. The second rotational speed (the second predetermined frequency) is lower than the aforementioned first rotational speed (the first predetermined frequency).

For example, in the present embodiment, when a first driving frequency is Fd1, a second driving frequency is Fd2, and a resonant frequency of a circuit capable of resonating is Fr which is determined according to the capacities of the capacitors 44b1 and 44b2, the inductance of the coils 32, and the like; then, Fd1/Fr is preferably larger than 1.0 and 3.0 or less, and more preferably larger than 1.0 and 2.0 or less. Further, Fd2/Fr is preferably 0.3 or larger and less than 1.0, and more preferably 0.6 or larger and less than 1.0.

Then, for example at the timing t1a shown in FIG. 4B, in order to magnetize the magnets 34 provided to the rotor 33 of the motor 30 shown in FIG. 2A, a control signal is sent to the switching unit 44 from the main control unit 20 shown in FIG. 1A, and the switching elements 44a1 and 44a2 are switched ON. As a result, the current supply lines 42a, 42b, and 42c are turned to a connected state via the capacitors 44b1 and 44b2.

When the current supply lines 42a, 42b, and 42c where currents having different phases are flowing are turned to a connected state, a short circuit current flows to each of the pair of lines via the capacitor, and due to this, amplitude of the current increases as shown in after the timing t1a shown in FIG. 4B (the right side of the t1a of FIG. 4B). Therefore, it is possible to flow a larger current (for example, three times or larger) than during the normal operation to the coils 32 of the motor 30 without changing the output from the inverter 46 or so shown in FIG. 1A. As a result, a higher magnetic field in positive side (for example, three times or higher) is applied to the magnets 34 of the motor 30 shown in FIG. 2A as shown in after the timing t1a of FIG. 5B. Thereby, the magnets 34 can be magnetized.

For example, regarding a hysteresis curve 34a of a B-H curve of the magnets 34 as shown in FIG. 3, the magnetization can be carried out at a sufficiently large magnetic field mh1 (in the positive side). In regards with a conventional control device which does not have the switching unit 44 shown in FIG. 1A, when the magnetization is carried out, it is carried out at a magnetic field of mh0. That is, in the present embodiment, the magnetization can be carried out even without increasing the output of the inverter 46 shown in FIG. 1A.

Also, at the timing t2a when the magnetization of the magnets 34 are completed (see FIG. 4B), the control signal is sent to the switching unit 44 from the main control unit 20 shown in FIG. 1A to switch OFF the switching elements 44a1 and 44a2. As a result, the connections between the current supply lines 42a, 42b, and 42c are disconnected from each other, hence short circuit currents do not flow.

When the connections between the current supply lines 42a, 42b, and 42c are disconnected, the current flowing in each of the current supply lines 42a, 42b, and 42c returns to the state of before the timing t1a as shown in after the timing t2a of FIG. 4B (the right side of FIG. 4B). Similarly, when the connections between the current supply lines 42a, 42b, and 42c are disconnected from each other, the magnetic field applied to each of the magnets 34 of the motor 30 returns to the state of before the timing t1a as shown in after the timing t2a of FIG. 5B (the right side of FIG. 5B). As a result, the motor 30 returns back to the normal operation.

Note that, in FIG. 4B and FIG. 5B, as similar to the cases of FIG. 4A and FIG. 5A, an electrical angle of a horizontal axis corresponds to a time span. The time span from the timing t1a to t2a may be the same or different from the aforementioned timing t1 to t2, and for example it is several milli seconds to several seconds. During this time span, all of the magnets 34 of the motor 30 are magnetized. After the magnets 34 are magnetized, the normal control of the motor 30 is carried out by the main control unit 20 shown in FIG. 1A.

In the present embodiment, as shown in FIG. 1A, by having the capacitor 44b1 connected in series to the switching element 44a1 and the capacitor 44b2 connected in series to the switching element 44a2, the route where the short circuit current flows can be changed into either a route which a capacitance impedance characteristic is dominating and a route which an induction impedance characteristic is dominating depending on the frequencies of the current.

By having the capacitor 44b1 connected in series to the switching element 44a1 and the capacitor 44b2 connected in series to the switching element 44a2, the route obtains a resonance point, and it becomes a route which a capacitance impedance characteristic is dominating at the second predetermined frequency having a lower frequency than the resonance point, and it becomes a route which an induction impedance characteristic is dominating at the first predetermined frequency having a higher frequency than the resonance point. Thus, at the first predetermined frequency, the coils 32 can easily generate the magnetic field suited for demagnetization of the magnets 34, and at the second predetermined frequency, the coils 32 can easily generate the magnetic field suited for magnetization of the magnets 34. Note that, a predetermined frequency corresponds to a driving speed of the motor (for example, a rotational speed).

### Second Embodiment

A control device 10a for a power generator 30a of the present embodiment shown in FIG. 1B is, for example, used for a wind turbine. However, it is not limited to this, and for example, it can be used for a hydropower generator, a geothermal steam generator, a wave power generator, tidal current power generation, and tidal power generation.

The power generator 30a has a similar structure to the motor 30 shown in FIG. 2B; and the power generator 30a has a rotor which rotates by being connected to a driving force generator such as a windmill (driven unit), and a stator including coils 32a, which are similar to the coils 32, arranged around the rotor. The rotor is installed with magnets similar to the magnets 34 as similar to the motor 30.

As shown in FIG. 1B, a main control unit 20a of the control device 10a for power generator outputs an instruction to the inverter 46 and the switching unit 44 for controlling the power generator 30a. As an example, the main control unit 20a may output a control signal to the inverter 46 and the switching unit 44, or it may output an instruction signal including data used for controlling the power generator 30a.

As shown in FIG. 1B, the main control unit 20a of the control device 10a for power generator outputs an instruction to the inverter 46 and the switching unit 44 for controlling the power generator 30a. As an example, the main control unit 20a may output a control signal to the inverter 46 and the switching unit 44, or it may output instruction signal including data used for controlling the power generator 30a.

Also, the main control unit 20a acquires information such as a rotational speed of the power generator 30a. For example, the main control unit 20 preferably acquires information such as a rotational speed (driven unit frequency) of a windmill (driven unit) of the power generator 30a via the detection unit 29 such as a resolver or a converter. Note that, the detection unit 29 for acquiring the rotational speed of power generator (driven unit frequency), the position of the rotor, and the like is not particularly limited, and an appropriate detection unit may be selected according to a type of the generator, a control method, and so on.

The main control unit 20a includes an instruction output unit 22a, an operation control unit 24a, a current-speed regulation unit 25a, an input unit 26a, a memory unit 27a, and the like. Note that, each of the instruction output unit 22a, the operation control unit 24a, the current-speed regulation unit 25a, the input unit 26a, the memory unit 27a, and the like respectively corresponds to the instruction output unit 22, the operation control unit 24, the current-speed regulation unit 25, the input unit 26, the memory unit 27, and the like of the first embodiment. Note that, since the targets to be controlled are different, that is, the motor 30 and the power generator 30a; hence, there may be parts with slightly different functions. In below, unless mentioned otherwise, it is similar to the first embodiment.

In the present embodiment, configurations of the voltage source 48, the inverter 46, and the switching unit 44 are similar to the configurations of the first embodiment. In the power generator 30a of the present embodiment, an output unit 60 is connected via an output-input switching unit 50. The output unit 60 is a circuit to output induced electromotive force generated in the coils 32a of the power generator 30a to outside.

The output-input switching unit 50 includes switching elements 54a, 54b, and 54c switching between a state where output lines 52a, 52b, and 52c, respectively connected to the coils 32a having three phases are connected to the output unit 60, and a state where the output lines 52a, 52b, and 52c are connected to the current supply lines 42a, 42b, and 42c. During the normal operation of the power generator 30a, the main control unit 20a shown in FIG. 1B controls the output lines 52a, 52b, and 52c using the switching elements 54a, 54b, and 54c to keep these connected to the output unit 60. Thereby, electric power generated by the power generator 30a can be taken out from the output unit 60.

In the case it becomes necessary to demagnetize or magnetize the magnets of the power generator 30a due to some reasons, the main control unit 20a sends a signal to the output-input switching unit 50, and switches to the state where the output lines 52a, 52b, and 52c are respectively connected to the current supply lines 42a, 42b, and 42c. If necessary, the main control unit 20a controls to disconnect the connection between the rotor of the power generator 30a and a power source such as a windmill, and controls so that the rotor of the power generator 30a can freely rotate independent from the power source.

In such state, as similar to the aforementioned first embodiment, the magnet can be demagnetized or magnetized. Note that, unlike in the case of the first embodiment, in the present embodiment, the rotor of the power generator 30a can rotate using natural energy such as wind power. Hence, in the present embodiment, ON/OFF of the switching elements of the switching unit 44 for short circuit are controlled according to the rotational speed of the rotor; and thereby, demagnetization or magnetization of the magnet can be controlled.

For example, the magnets of the power generator such as a windmill may be demagnetized or degaussed due to lightning and so on. In such case, conventionally, an extensive work will be needed to collect, transport, and dissemble to exchange the magnet; hence, this will be extremely high cost particularly in the case of an offshore wind turbine.

In the control device 10a of the power generator 30a of the present embodiment, by using the similar device as the control device 10 of the motor 30 of the aforementioned first embodiment, the magnets can be easily re-magnetized without exchanging the magnets of the power generator 30a. Also, by using the device 10a similar to the control device 10 of the motor 30 of the aforementioned first embodiment, demagnetization and magnetization of the magnets of the power generator 30a can be done freely, and an efficiency of the power generator 30a can be improved.

Note that, in the present embodiment, the voltage source 48 may be a power storage device partially storing electric power taken out of the output unit 60 of the power generator 30a. Also, in the power generator 30a of the present embodiment, the coils 32a used for output of the power generation also function as coils to demagnetize or magnetize the magnets of the power generator 30a; however, these coils may be prepared separately according to the purpose of use.

### Third Embodiment

In the present embodiment, specific configurations of a power generator 30a shown in FIG. 1B are different from those of the second embodiment. The power generator 30a of the present embodiment is configured as shown in FIG. 2B, and other than the control device 10a being configured as described in below, the power generator 30a of the present embodiment has similar configurations as the second embodiment, and the same explanations will be omitted.

As shown in FIG. 2B, the power generator 30a of the present embodiment includes a rotor 33a of a tubular shape as a rotor which rotates by being connected to a driving force generator such as a windmill (driven unit). At an inner circumference of the rotor 33a, many magnets 34 are arranged along the circumference direction and roughly evenly spaced apart from each other. Also, a shaft 31a as a stator, which includes coils 32a arranged in a predetermined interval so as to face the magnets 34, is installed to the inside of the rotor 33a.

The control device 10a for the power generator 30a according to the present embodiment includes a main control unit 20a controlling the movement of the switching unit 44 shown in FIG. 1B, and a detection unit 29 detecting a driven frequency of a windmill and the like as a driven unit of the power generator 30a. The detection unit 29 is, for example, arranged near the driven unit of the power generator 30a; and although it is not particularly limited, examples of the detection unit 29 include a rotational angle sensor such as a resolver capable of acquiring information such as a rotational speed (driven frequency) of a windmill, an angular speed sensor, and other sensors.

The main control unit 20a includes a comparison unit 28 comparing a driven frequency detected by the detection unit 29 and a resonant frequency of a coil capable of resonating by being configured of a capacitor included in a circuit including the coils 32a of the power generator 30a, a switching unit, or other circuit (a circuit from the invertor to the power generator 30a). The main control unit 20a determines in a comparison unit 28 whether the driven frequency from the detection unit 29 is substantially the same or less than the resonant frequency of a circuit capable of resonating which is memorized in the memory unit 27a. Upon detecting that the driven frequency is substantially the same or lower than the resonant frequency at the comparison unit 28, the switching elements 44al and 44a2 of the switching unit 44 are controlled to switch the current supply lines 42a, 42b, and 42c to a connected state, and thereby the magnets 34 shown in FIG. 2B is magnetized.

When the driven frequency detected by the detection unit 29 is for example 0.3 times or less of the resonant frequency of the circuit capable of resonating, if the switching unit 44 is controlled to switch the current supply lines 42a, 42b, and 42c to a connected state, the increase in the current amplitude supplied by the invertor 46 and the like is insufficient; hence, it may be difficult to magnetize the magnets 34 in some cases.

When the driven frequency detected by the detection unit 29 is detected to be substantially the same or less than the resonant frequency of the circuit capable of resonating, the switching unit 44 is controlled to switch the current supply lines 42a, 42b, and 42c to a connected state at a timing t1a (see FIG. 4C). In such case, the current amplitude supplied by the invertor 46 is increased to 3 times or larger as shown FIG. 4C. As a result, as shown in FIG. 5C, the magnetic field applied to the magnets 34 increases after the timing t1a, and the magnets can be magnetized effectively.

The magnets 34 of the power generator such as a wind turbine, for example, there may be cases that the magnet is demagnetized or degaussed due to lightning strike. In such case, conventionally, an extensive work will be needed to collect, transport, and dissemble to exchange the magnet; hence, this will become extremely high costs particularly in the case of an offshore wind turbine.

In the control device 10a of the power generator 32a of the present embodiment, by using the device similar to the control device 10a of the power generator 30a of the aforementioned second embodiment, the magnets 34 can be easily magnetized without exchanging the rotor 33a including the magnets 34 of the power generator 30a. Also, by using the device 10a similar to the control device 10a of the motor 30a of the aforementioned second embodiment, the magnets 34 of the power generator 30a can be easily re-magnetized.

Thereby, the costs for exchanging the magnets including collecting, transporting, and dissembling of the power generator can be reduced; and thus, an extensive work is not needed. Therefore, particularly in the case of an offshore wind turbine, it is possible to reduce the extremely high maintenance fee.

Note that, in FIG. 4C and FIG. 5C, an electrical angle shown in a horizontal axis corresponds to a time span, and a time span from the timing t1 to the timing t2 is, for example, several milli seconds to several seconds. During this time span, all of the magnets 34 of the power generator 30a are magnetized. After the magnets 34 are magnetized, the normal control of the power generator 30a is carried out by the main control unit 20 shown in FIG. 1B.

Also, in the present embodiment, when the driven frequency of the driven unit detected by the detection unit 29 is Fd and the resonant frequency of the circuit capable of resonating is Fr, Fd/Fr is preferably 0.3 or larger and smaller than 1.0, and more preferably 0.6 or larger and less than 1.0. Further, in the present embodiment, as the driven frequency detected by the detection unit 29, it is not limited to a rotational frequency of a windmill and the like, and it may also be a frequency of movement other than rotation. Also, the frequency of the three-phase current used for magnetization of the power generator is preferably lower than the resonant frequency of the circuit, as similar to the case of the motor.

The present disclosure is not limited to the above-mentioned first embodiment, second embodiment, and third embodiment; and a modified embodiment may be configured by combining some of the elements from these embodiments, and also the modified embodiment may be configured by omitting some of the elements from the above-mentioned embodiments.

For example, in the embodiments shown in FIG. 1A and FIG. 1B, among the three current supply lines 42a, 42b, and 42c, the switching element 44a1 and the capacitor 44b1 are provided between the current supply lines 42a and 42b, and the switching element 44a2 and the capacitor 44b2 are provided between the current supply lines 42b and 42c. However, it is not particularly limited to such configuration.

For example, as long as a switching element is included between at least one pair among the three current supply lines 42a, 42b, and 42c, the effects similar to the above-mentioned embodiments can be exhibited. Note that, the switching element is provided between preferably to two or more pairs of the current supply lines among the three current supply lines 42a, 42b, and 42c. More preferably, per each switching element, at least one capacitor is connected in series to the switching element.

Note that, in the switching unit 44, the capacitors 44b1 and 44b2 are preferably connected in series to the switching elements between any one or more of pairs selected from the current supply lines 42a, 42b, and 42c; however, it is not particularly limited to this configuration. For example, even if a capacitor is not provided in the switching unit 44, a capacitor may be connected in series to each of the switching elements 44a1 and 44a2 at any position of the circuits 40 and 40a.

Also, the capacitor connected in series to the switching element may be arranged inside of the motor 30 or the power generator 30a, or inside of the inverter 46. Note that, when the switching elements 44a1 and 44a2 and the current supply lines 42a, 42b, and 42c are in a disconnected state between each other, from the point of stopping the function of the capacitor, the capacitor is preferably arranged between the switching element and the current supply line connected in series to the switching element.

Also, the above-mentioned embodiments use a variable flux magnet of low coercivity as the magnet 34; however, it is not limited to this. At least one of the magnets 34 configuring the magnetic pole of the motor 30 (the same applies to the power generator) may be a variable magnetic flux magnet of low coercivity. Also, for example, one or more magnets 34 may be a compound of a plurality of magnets made of a variable magnetic flux magnet of low coercivity and a fixed magnetic flux magnet of high coercivity. The variable magnetic flux magnet and the fixed magnetic flux magnet in the compound of magnets may be arranged in series, parallel, or a combination of these. Also, the magnets 34 may be configured only from the fixed magnetic flux magnets of high coercivity.

Further, the motor of the above-mentioned embodiments is a motor including a rotor and a stator; however, it may be other motors such as a linear motor. Also, the magnet is preferably provided to the rotor; however, it may be provided to the stator. Also, the instruction output units 22 and 22a of the main control units 20 and 20a of the above-mentioned embodiments, the operation control units 24 and 24a, the current-speed regulation units 25 and 25a, the input units 26 and 26a, and the comparison unit 28 may be configured of specialized circuits; however, these may be programs executed by a computer.

REFERENCE SIGNS LISTS
10 . . . Control device for motor
10a . . . Control device for power generator
20, 20a . . . Main control unit
22, 22a . . . Instruction output unit
24, 24a . . . Operation control unit
25, 25a . . . Current-speed regulation unit
26, 26a ... Input unit
27, 27a . . . Memory unit
28 . . . Comparison unit
29 . . . Detection unit
30 . . . Motor
   30a . . . Power generator
31 . . . Stator
   31a . . . Shaft
32, 32a . . . Coil
33, 33a . . . Rotor
34 . . . Magnet
   34a . . . Hysteresis curve
40 . . . Circuit
   42a, 42b, 42c . . . Current supply line
44 . . . Switching unit
   44a1, 44a2 . . . Switching element
   44b1, 44b2 . . . Capacitor
46 . . . Invertor
48 . . . Voltage source
50 . . . Output-input switching unit
52a, 52b, 52c . . . Output line
54a, 54b, 54c . . . Switching element
60 . . . Output unit

What is claimed is:

1. A control device for a motor comprising:
current supply lines respectively supplying currents having different phases to coils of the motor having a magnet, and
a switching unit switching a non-connected state and a connected state between the current supply lines.

2. The control device for the motor according to claim 1, wherein the switching unit comprises a switching element switching the non-connected state and the connected state between the current supply lines.

3. The control device for the motor according to claim 2 further comprising a capacitor connected in series to the switching element.

4. The control device for the motor according to claim 1, wherein a part of or all of the magnet or magnets are variable magnetic flux magnets of low coercivities.

5. The control device for the motor according to claim 1 further comprising a control unit controlling a driving frequency of the motor and a movement of the switching unit,
wherein the control unit controls the driving frequency to a first predetermined frequency and controls the switching unit to bring the current supply lines to the connected state, and demagnetizes the magnet.

6. The control device for the motor according to claim 5, wherein the control unit controls the driving frequency to a second predetermined frequency and controls the switching unit to bring the current supply lines to the connected state, and magnetizes the magnet; and
the second predetermined frequency is lower than the first predetermined frequency.

7. The control device for the motor according to claim 1 further comprising an inverter supplying the motor with the currents having different phases.

8. A motor comprising the control device for the motor according to any one of claims 1 to 7.

9. A control device for a power generator comprising:
current supply lines respectively supplying currents having different phases to coils of the power generator having a magnet, and
a switching unit switching a non-connected state and a connected state between the current supply lines.

10. The control device for the power generator according to claim 9, wherein the switching unit comprises a switching element switching the non-connected state and the connected state between the current supply lines.

11. The control device for the power generator according to claim 10 further comprising a capacitor connected in series to the switching element.

12. The control device for the power generator according to any one of claims 9 to 11 further comprising:
a control unit controlling a detection unit detecting a driven unit frequency of a driven unit of the powder generator, and controlling a movement of the switching unit;
wherein the control unit magnetizes the magnet by bringing the current supply lines to the connected state by controlling the switching unit upon detecting that the driven unit frequency detected by the detection unit is substantially the same as or lower than a resonant frequency of a circuit capable of resonating by being configured of a circuit including the coils of the power generator and a circuit of the switching unit.

13. A power generator comprising the control device for the power generator according to any one of claims 9 to 12.

14. A wind turbine comprising the control device for the power generator according to any one of claims 9 to 12.
